(19) United States
(12) Patent Application Publication
(10) Pub. No.: US 2013/0305490 A1
(43) Pub. Date: Nov. 21, 2013

(54) D-Profile Door Pull

(71) Applicant: Gary Sprague, Los Angeles, CA (US)

(72) Inventor: Gary Sprague, Los Angeles, CA (US)

(21) Appl. No.: 13/610,564

(22) Filed: Sep. 11, 2012

Related U.S. Application Data
(60) Provisional application No. 61/648,037, filed on May 16, 2012.

(51) Int. Cl. E05B 1/00

(52) U.S. Cl. 16/412

(57) ABSTRACT

An improved door pull assembly for glass doors having inner and outer horizontal pull members, as well as a vertical pull member is presented. The door pull members have a cross-sectional shape in the form a “D,” wherein the curved portion of the D faces inwardly towards the door glass. The D-shaped cross-section better fits the human hand and therefore a user is less likely to lose his grip on the pull when opening a glass door.

### CROSS-REFERENCE TO RELATED APPLICATION

This application claims the benefit of U.S. Provisional Application No. 61/648,037, filed on May 16, 2012.

### FIELD OF THE INVENTION

The invention relates to door pulls for glass doors and more to particularly to door pulls having a D-shape on their inside curvature. The invention is suitable for use with fixed door pulls and with “panic handles.”

### BACKGROUND OF THE INVENTION

Glass doors are used to allow people inside a room to see outside through the doors and likewise to allow people outside the room to see inside. Glass doors are attractive and allow sunlight or other ambient light to enter the room and increase illumination. Glass doors also create a greater sense of open space and have the effect of making a room appear larger. Glass doors are now a common feature found in office buildings throughout the United States.

As with any door, there is a need for a door pull to open a glass door. In the case of glass doors used in office settings, most commonly, the door hinges are spring loaded and therefore the doors are self closing. Hence, there is typically only a need to open the door and no need to physically close the door.

Prior art glass door pulls are commonly made of steel or acrylic tubing having a round cross-section. Prior art glass door pulls with round cross-sections, though functional, have a tendency to slip in a user's hand because the round cross-section of the pull does not conform well to a typical human hand. Attempts have also been made to produce glass door pulls fabricated from glass panels. Pulls of this type generally have a planar gripping surface, which also does not conform well to the human hand.

Glass door pulls also comprise a category of devices known in the art as “panic handles.” A panic handle is used with a lockable door. A panic handle has the ability to unlock a locked door by simply pressing on the handle. Commonly, panic handles are installed as interior handles in rooms with doors that are lockable from the outside. Thus, if an individual is accidentally locked in a room, he or she may readily exit the room by depressing the panic handle. Most panic handles currently in production are made from round tubing similar to fixed door pulls and consequently suffer from the same hand slippage problems associated with fixed door pulls, i.e. the door pull does not readily conform to the human hand U.S. Pat. Nos. 4,366,974 to Horgan; 4,382,620 to Horgan; and, 4,506,922 to Horgan are representative of panic handle designs. Notably, each reference refers to a handle composed of tubing having a circular cross section.

As may be seen, there remains a need for a glass door pull that has a cross-sectional shape that better fits the human hand and therefore is more easily grasped by the user and hence is less likely to slip when pulled. Ideally, such a door pull would also include a vertical pull/push bar to accommodate tall individuals for whom reaching for the horizontal pulls may be inconvenient. Horizontal door pulls are typically mounted at the mid-height or lower of the glass door.

### SUMMARY OF THE INVENTION

The invention comprises an improved glass door pull having inner and outer horizontal pull members as well as a vertical pull member. In an alternative embodiment, the door pull comprises a vertical pull only. The pull members whether horizontal or vertical have a cross-sectional shape in the form a “D.” The inventor has found that a D-shaped cross-section better fits the human hand and therefore a user is less likely to lose his grip on the pull when in use. The D-shaped cross-section of the present invention is equally suitable for use in fixed door pulls and in “panic handles.” Other objects and advantages of the present invention will become apparent in the course of the following description.

### BRIEF DESCRIPTION OF THE DRAWINGS

FIG. 1 is a perspective view of an exemplary embodiment of the D-shaped door pull of the present invention;

FIG. 2 is a front plan view of the exemplary door pull of FIG. 1;

FIG. 3 is a right side view of the exemplary door pull of FIG. 1;

FIG. 4 is a top plan view of the exemplary door pull of FIG. 1;

FIG. 5 is a front perspective view of the exemplary door pull of FIG. 1;

FIG. 6 is a partial perspective view of the lower right corner of the exemplary door pull of FIG. 1;

FIG. 7 is a perspective view of an exemplary embodiment of the D-shaped door pull of the present invention, arranged in a vertical configuration, wherein the door pull spans substantially the height of the door;

FIG. 8 is a perspective view of an exemplary embodiment of the D-shaped door pull of the present invention, arranged in a vertical configuration, wherein the door pull spans a comparatively short portion of the height of the door;

FIG. 9 is a perspective view showing a method of attachment of door pulls to glass doors, suitable for use with the present invention door pull; and

FIG. 10 is a cross sectional view showing a prior art method of attaching mutually opposed inner and outer door pulls to glass doors, suitable for use with the door pull of the present invention.

### DETAILED DESCRIPTION OF THE PREFERRED EMBODIMENT

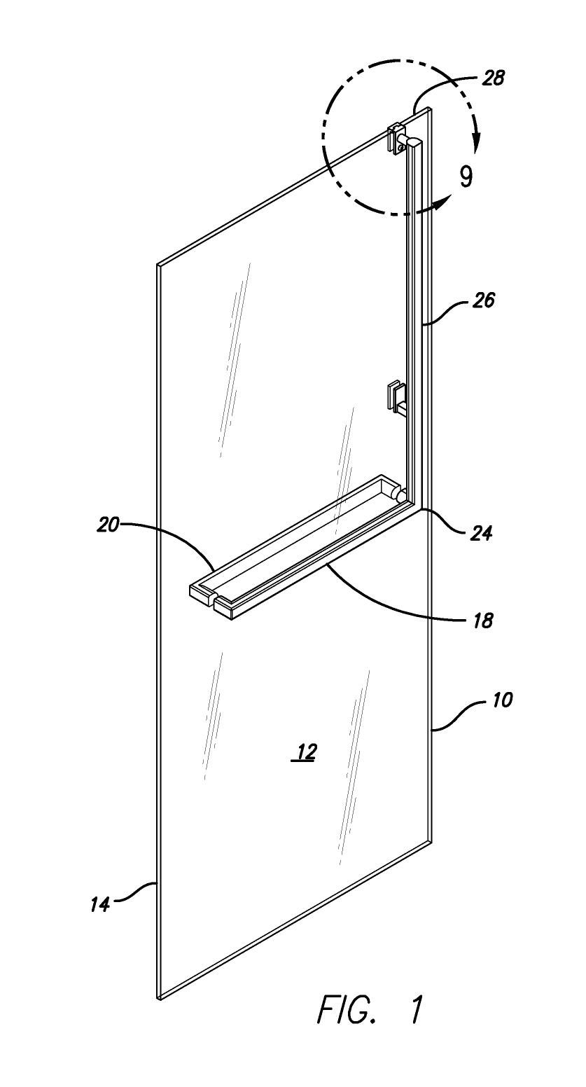

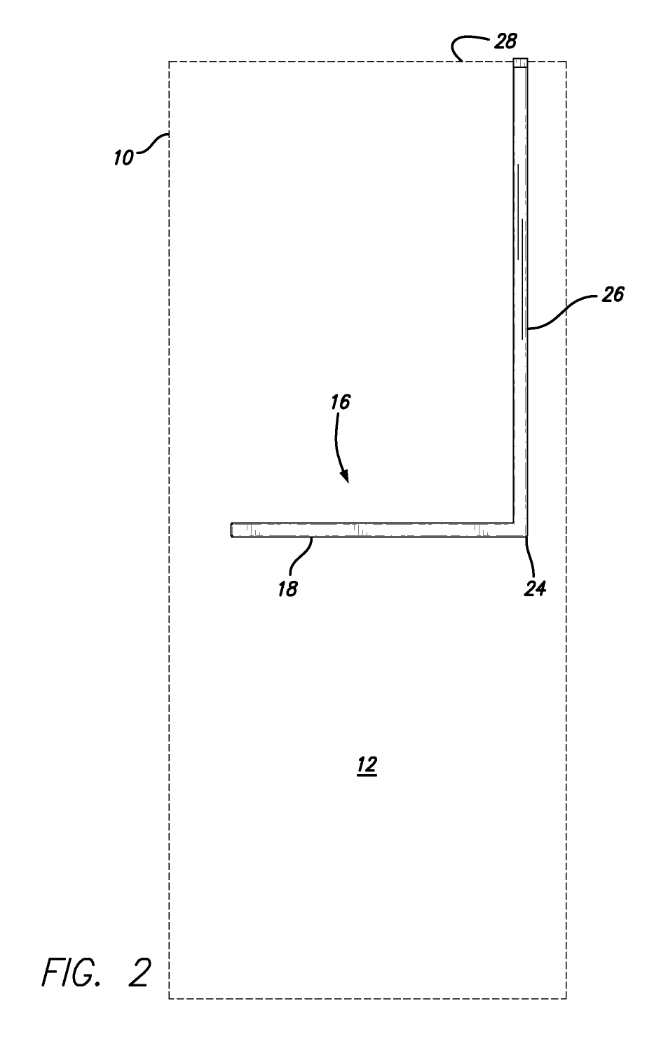

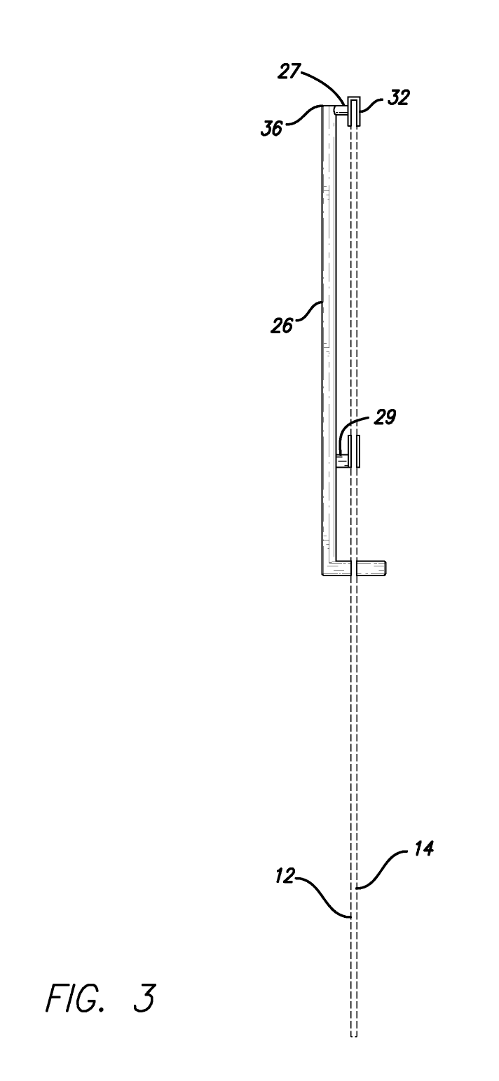

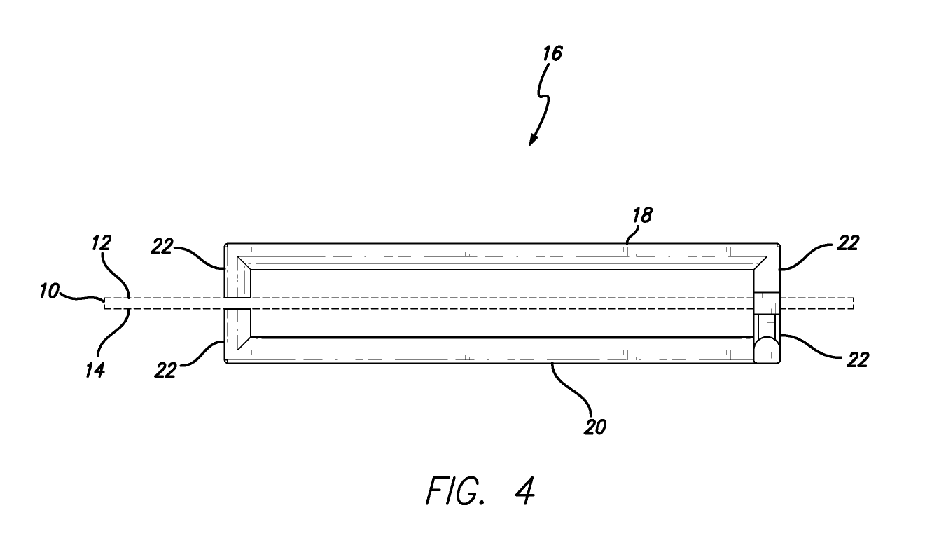

Referring to FIG. 1-4, with respect to a room, a door glass 10 has an inside surface 14 and an outside surface 12. In an exemplary embodiment, the door pull 16 of the present invention has outer horizontal pull member 18 on the outside surface 12 of the door glass 10. Directly opposed to the outer horizontal pull member 18 is an inner horizontal pull member 20 on the inside surface 14 of the door glass 10. The inner and outer horizontal door pull members, 20 and 18 respectively, are stood-off from the inner and outer surfaces, 14 and 12, of the door glass 10 by standoffs 22 located at each end of the horizontal pull members 18 and 20.

At an end 24 of the outer horizontal door member 18 which is remote from the door hinge (not shown), the outer horizontal pull member 18 connects to a vertical pull member 26. The vertical pull member 26 runs vertically from the outer horizontal pull member 18 to an upper edge 28 of the door glass 10. The vertical pull member is supported and stood-off from the door glass 10 by an upper standoff 27 and by a lower standoff 29.

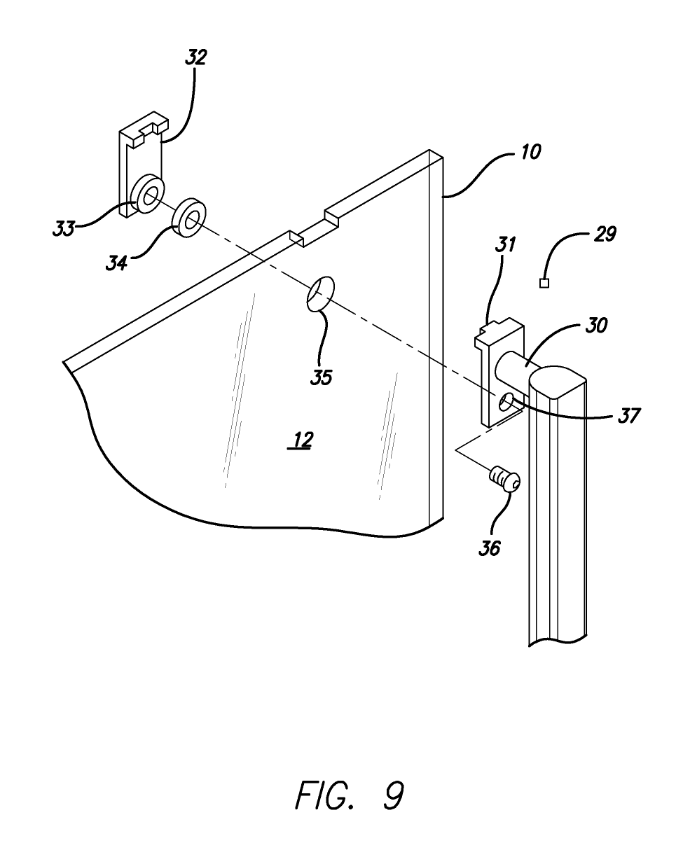

With reference to FIG. 9, the upper standoff 27 is single component comprised of a horizontal standoff portion 30 and a plate portion 31. The plate portion 31 includes a through-hole 37. Mounted on the opposite side of the glass door from the standoff 27 is a retainer plate 32. The retainer plate 32 includes a threaded insert 33 fixed to the retainer plate 32. Between the standoff 27 and the retainer plate 32 is a through-hole 35 in the door glass 10. Upon assembly of the door pull to the door glass, a bushing 34 is disposed within the through-hole 35 of the door glass. A cap screw 36 extends through the holes 35 and 37 in the upper standoff 27 and door glass 10, respectively, to engage the threaded insert 33 of the retainer plate 32. The door pull 16 of the present invention is firmly attached to the door glass upon the cap screw 36 being tightened. The lower standoff 29 likewise attaches the door pull 16 to the door glass in the same manner as described for the upper standoff 27.

The exemplary embodiment of the present invention door pull 16 is described as having the vertical pull member 26 placed on the outer surface 12 of the door glass 10. Those skilled in the art however, will readily understand that the vertical pull member 26 could also be located on the inside surface 14 of the door glass 10 by simply creating a mirror image of the design shown in FIGS. 1-6.

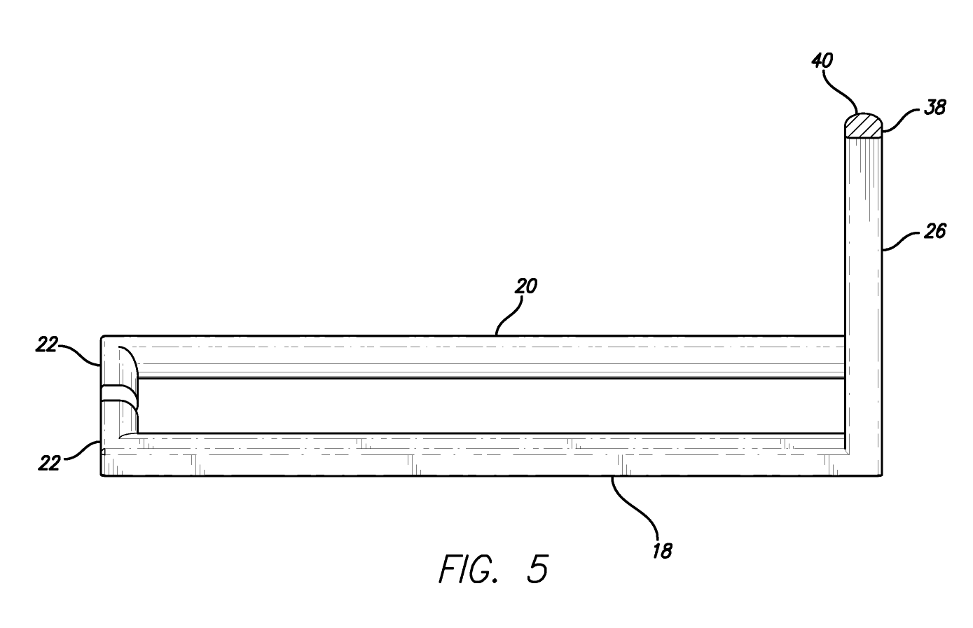

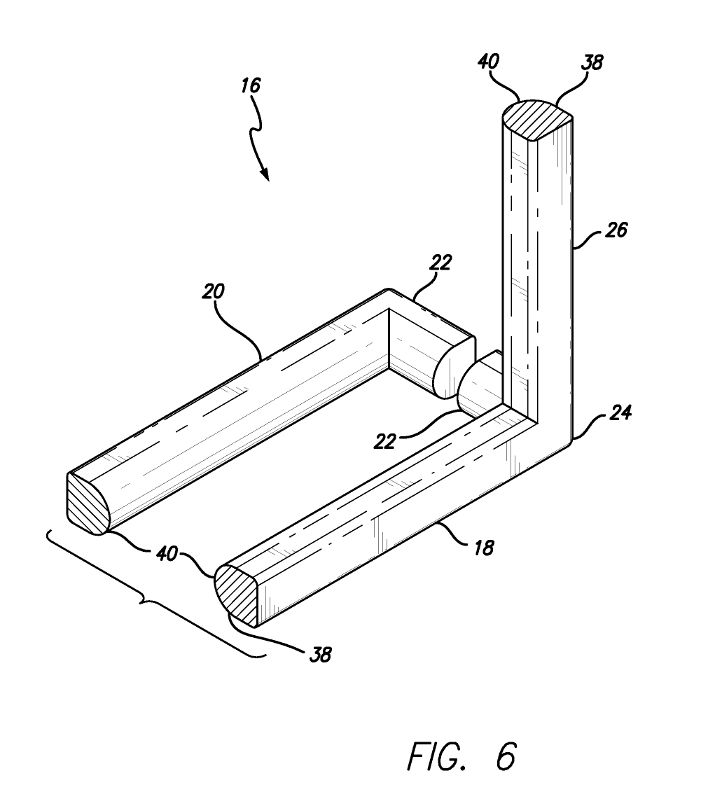

As best shown in FIGS. 5 and 6, the cross-sectional shape of the inner and outer horizontal pull members 20 and 18, the vertical pull member 26, and the standoffs 22 is a D-shape cross-section 38. It is desirable that the curved section 40 of the D-shaped portion of the cross-section 38 of the horizontal pulls, 18 and 20, and vertical pull 26 be directed inwardly towards the door glass 10. This allows the fingers of a user's hand to conveniently slip around and grasp the door pull 16. The inventor has found that the D-shaped cross-section 38 better fits the human hand and therefore a user is less likely to lose his grip on the pull when in use. A door pull with the D-shaped cross-section 38 results in a safer door pull and thus is an improvement over the prior art due a user's ability to maintain a better grip on the door pull.

In the exemplary embodiment, the door pull assembly 16 is manufactured of extruded mild steel tubing, the tubing having the D-shaped cross-section 38. The tubes which form the inner 20 and outer 18 horizontal pull members are cut at 45 degree angles and welded to the standoffs 22 which are likewise cut at 45 degree angles. At the corner point 24 of the outer horizontal 18 and vertical 26 pull members, the horizontal pull member 18 and the vertical pull member 26 are also cut at 45 degree angles and welded together. In this instance, standoff 22 is cut flat to facilitate welding to the corner point 24, which comprises the intersection of the outer horizontal 18 and vertical 26 pull members. The lower standoff 27 and the upper standoff 29 are also welded to vertical pull member 26, as is known in the art. When the welding operations are completed, the welds are ground smooth and subsequently the door pull assembly 16 of the present invention may be buffed and chrome plated.

The door pull assembly 16 may also be fabricated from stainless steel and finished in either a polished or brushed finish. The door pull assembly 16 may also be fabricated from aluminum and given an anodized or polished finish. The door pull assembly 16 may also be made of acrylic and many other types of plastic, as is known in the art. For aesthetic reasons, clear plastics are generally to be preferred.

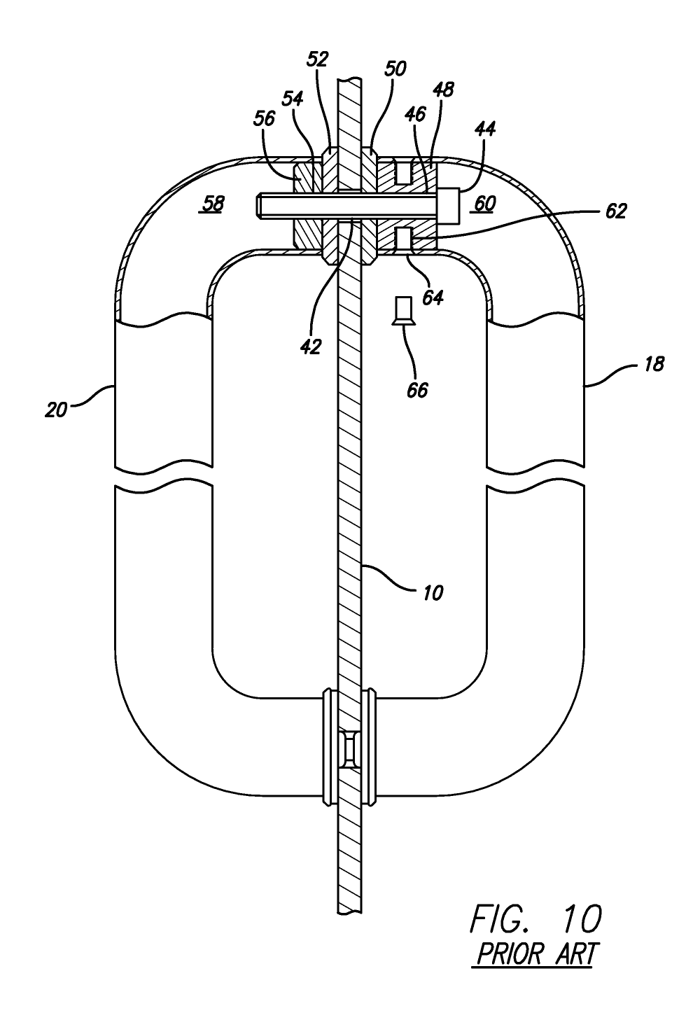

The inner and outer horizontal pull members 18 and 20 may be attached to the door glass via mechanical means as is known in the art. One such method is described here. With reference to FIG. 10, the door glass 10 has two through holes 42, one at each end of the horizontal door pulls. The through holes 42 are aligned with openings in the horizontal pull members 18 and 20. Prior to installation of the horizontal door pulls 18 and 20, an adjusting screw 44 is passed through a clearance hole 46 in a stop block 48. The screw 44 continues to pass through outer and inner washers 50 and 52 and into a threaded hole 54 of a threaded block 56. Screw 44 is then sufficiently tightened to achieve a snug fit of stop block 48, washers 50 and 52, and threaded block 56 to the door glass 10.

An opening 58 in the inner door pull 20 is fitted over the threaded block 56 and is attached to the threaded block via a press fit, structural adhesive or via mechanical fasteners such as screws, or via other means as known in the art. An opening 60 in the outside horizontal pull member 18 is fit over the stop block 48. The stop block 48 includes threaded holes 62 which align with holes 64 in the outer door pull 18. Screws 66 attach the outer door pull 18 to the stop block 48 via the threaded holes 62.

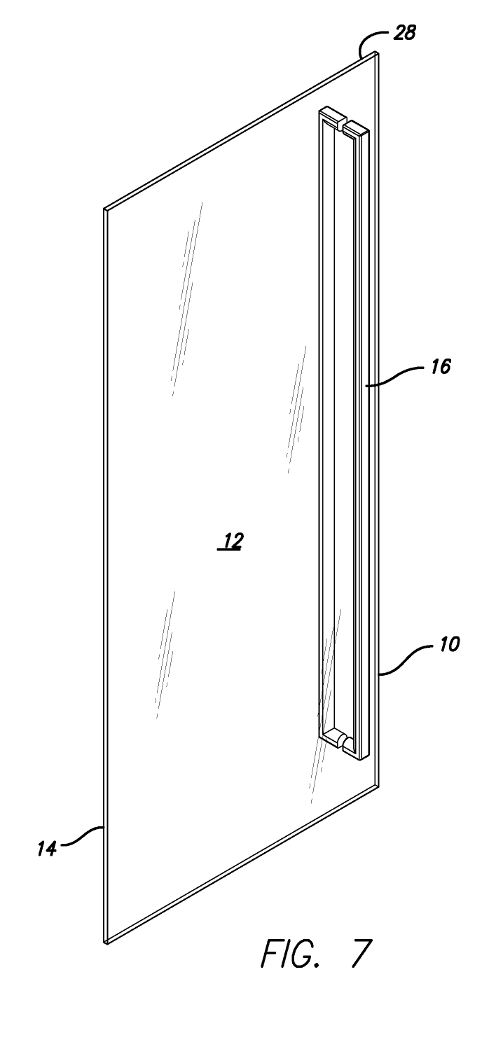

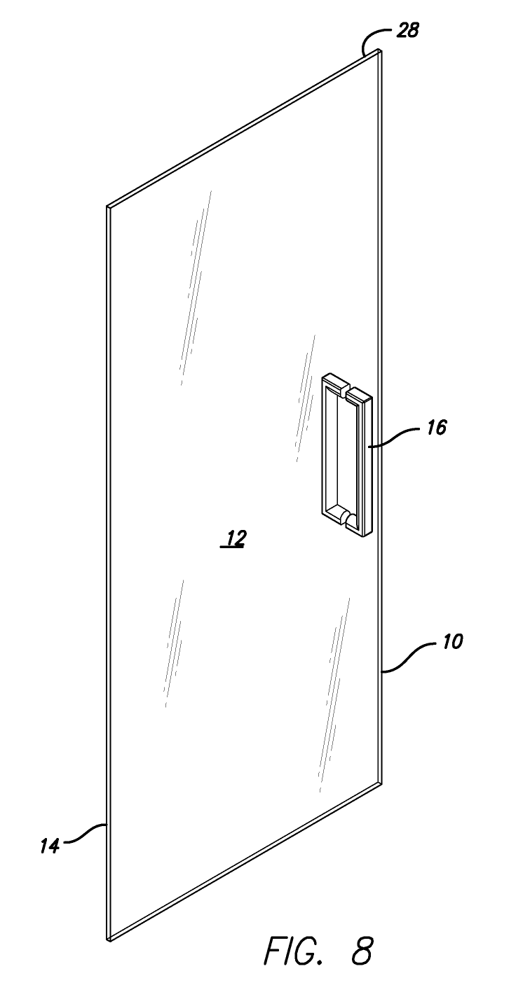

Referring to FIGS. 7 and 8, in alternative embodiments, the D-shaped door pull 16 of the present invention may be oriented solely as a vertical pull. The pull may be of varying lengths. In the embodiment shown in FIG. 7, the door pull extends along a substantial portion of the length of the door. Lengths of up to about 72″ are suitable for long door pulls. FIG. 8, by contrast, shows a vertical door pull which is comparatively short in relation to the height of the door. Short door pulls are often in the range of about 6″ to 18″ in length.

The foregoing detailed description and appended drawings are intended as a description of the presently preferred embodiments of the invention and are not intended to represent the only forms in which the present invention may be constructed and/or utilized. Those skilled in the art will understand that modifications and alternative embodiments of the present invention which do not depart from the spirit and scope of the foregoing specification and drawings, and of the claims appended below are possible and practical. It is intended that the claims cover all such modifications and alternative embodiments.

1. A door pull assembly for glass doors, comprising:
a glass door;
an inner horizontal door pull member;
an outer horizontal door pull member;
wherein the inner and outer horizontal door pull members are directly facing each other on opposite sides of the glass door;
means for connecting the inner and outer door pull members to the glass door;
a vertical door pull member connected to the glass door;
means for connecting the vertical door pull member to the glass door; and
the inner and outer horizontal door pull members having a D-shaped cross-section, whereby the D-shape of the cross-section conforms to a users' hand and provides a better grip on the door pull.

2. The door pull assembly for glass doors of claim 1, wherein the D-shaped cross-section of the inner and outer horizontal door pull members is oriented so that a curved portion of the cross-section faces inwardly towards the glass door.

3. The door pull assembly for glass doors of claim 1, wherein the vertical pull member is connected to the outer horizontal door pull member at an end distal from the door hinge.

4. The door pull assembly for glass doors of claim 1, wherein the vertical pull member is connected to the inner horizontal door pull member at an end distal from the door hinge.

5. The door pull assembly for glass doors of claim 1, wherein the vertical door pull member has a D-shaped cross section.

6. The door pull assembly for glass doors of claim 1, wherein a curved portion of the D-shaped cross-section of the vertical pull member faces inwardly towards the glass door.

7. The door pull assembly for glass doors of claim 1, wherein the length of the vertical pull member is defined by the vertical distance from the horizontal door pull members to a top edge of the door.

8. The door pull assembly for glass doors of claim 1, wherein the vertical door pull member is supported and stood off from the door at, at least two points, wherein one point is a corner of a horizontal door pull member.

9. A door pull assembly, comprising:
an inner horizontal door pull member;
an outer horizontal door pull member;
wherein the inner and outer horizontal door pull members are directly facing each other on opposite sides of the door;
means for connecting the inner and outer door pull members; and
the inner and outer horizantal door pull members having a D-shaped cross-section, whereby the D-shape of the cross-section conforms to a users' hand to and provides a better grip on the door pull.

10. The door pull assembly of claim 9, wherein the D-shaped cross-section of the inner and outer horizontal door pull members is oriented so that a curved portion of the cross-section faces inwardly towards the door.

11. The door pull assembly of claim 9, wherein the outer horizontal door pull member includes a vertical pull member connected to the outer horizontal door pull member at an end distal from the door hinge.

12. The door pull assembly of claim 11, wherein the vertical door pull member has a D-shaped cross section.

13. The door pull assembly of claim 12, wherein a curved portion of the D-shaped cross-section of the vertical door pull member faces inwardly towards the door.

14. The door pull assembly of claim 11, wherein the length of the vertical door pull member is defined by the vertical distance from the outer horizontal door pull member to a top edge of the door.

15. The door pull assembly of claim 11, wherein the vertical door pull member is supported and stood off from the door at three points.

16. The door pull assembly of claim 9, wherein the inner horizontal door pull member includes a vertical pull member connected to the inner horizontal door pull member at an end distal from the door hinge.

17. A door pull comprising, a door pull member wherein the door pull has a D-shaped cross-section, and further wherein the D-shape of the cross-section conforms to a users' hand, whereby the D-shaped cross-section provides a better grip on the door pull.

18. A door pull assembly, comprising:
a vertical door pull member;
means for connecting the vertical door pull member to a door; and
the vertical door pull member having a D-shaped cross-section, wherein the D-shape of the cross-section conforms to a users' hand and provides a better grip on the door pull.

19. The door pull assembly of claim 18, wherein the D-shaped cross-section of the vertical door pull member is oriented so that a curved portion of the to cross-section faces inwardly towards the door.

20. The door pull assembly of claim 18, wherein the door pull includes inner and outer vertical door pull members directly facing each other on opposite sides of the door.
